(19) United States
(12) Patent Application Publication
(10) Pub. No.: US 2022/0088961 A1
(43) Pub. Date: Mar. 24, 2022

(54) EMBEDDING STRUCTURE FOR WHEEL COVER FITTED TO ALUMINUM ALLOY WHEEL RIM

(71) Applicant: SOUN MIIN CO., LTD., TAINAN CITY (TW)

(72) Inventor: FU-YUAN HSIEH, TAINAN CITY (TW)

(21) Appl. No.: 17/026,403

(22) Filed: Sep. 21, 2020

(51) Int. Cl. B60B 7/06; B60B 7/12

(52) U.S. Cl. CPC B60B 7/066; B60B 7/12

(57) ABSTRACT

The present invention discloses an embedding structure for a wheel cover fitted to an aluminum alloy wheel rim. It comprises a wheel cover having a long slot at a middle, plural engaging legs around the long slot at an inner end surface and each having a positioning protrusion at an outer terminal toward the long slot, two withstanding protrusions protruded from an outer end surface at two ends of the long slot and an engaging groove between the two withstanding protrusions; and a supporting seat disposed in a space defined by the plural engaging legs which has a connection segment at a middle, a tenon connected to the connection segment and corresponding to the long slot, an annular groove formed at an outer edge and corresponding to the positioning protrusion of each of the plural engaging legs for pushing the positioning protrusions outwardly and expanding the plural engaging legs outwardly.

### BACKGROUND OF THE INVENTION

### 1. Field of the Invention

The present invention relates to an embedding structure for a wheel cover fitted to an aluminum alloy wheel rim which has a wheel cover and a supporting seat to easily and rapidly position and install on a wheel rim so as to improve its whole practical feature.

### 2. Description of Related Art

Different kinds of cars are extensively utilized by people to shorten their traveling time from a place to another place. In addition, people can also go out by cars in a windy raining day without exposing to the wind and the rain. Car tires installed at a bottom of the car are important components of the car to move on a road successfully. The car tire mainly comprises a metal wheel rim and a tire surrounds the metal rim, so the car can stably moving on the road by an elasticity of the car tire after the tire is inflated with air.

The metal wheel rim of the car tire is usually made of iron or aluminum alloy and covered by a wheel cover at an outer end surface to improve its aesthetics. A conventional aluminum alloy wheel rim comprise ribs and engraved holes and does not require the wheel cover because it is painted and anodized, and has aesthetics. However, foreign objects, e.g. gravels or irons, block on the road usually bounce to hit the conventional aluminum alloy wheel rim due to the pressure of fast-moving car tires running over the foreign objects, so the conventional aluminum alloy wheel rim is easily damaged and has scratches or pits on its surface. In addition, foreign objects attached on the conventional aluminum alloy wheel rim are not easily cleaned and thus reduces the aesthetics. Therefore, in order to protect the conventional aluminum alloy wheel rim, a wheel cover is also installed. Furthermore, to increase the aesthetics of the conventional aluminum alloy wheel rim and a unique sense of a car, a wheel cover made of plastic and having a bright appearance or a mate plating layer is also installed on the conventional aluminum alloy wheel rim.

Although the current domestic laws does not prohibit installing the wheel cover on the wheel rim, the installation of the wheel cover on the wheel rim still needs to meet the safety requirement such as not falling from the wheel rim when the car is moving. Therefore, different techniques to install a wheel cover to a wheel rim are developed. For instance, a cover structure for a wheel rim is disclosed by the Taiwan Pat No. TWM280307(U) issued on 11 Nov. 2015; a hubcap of an aluminum alloy wheel rim is disclosed by the Taiwan Pat No. TW547351(U) issued on 11 Aug. 2003; and a wheel cover structure for an aluminum alloy wheel rim is disclosed by the Taiwan Pat No. TWM275112(U) issued on 11 Sep. 2005. However, even the same type of aluminum alloy wheel rims manufactured by different foundries usually have some differences in size and position, so the wheel cover may not install on the aluminum alloy wheel rims successfully. For instance, engaging protrusions of the wheel cover cannot engage with engraved holes of the aluminum alloy wheel rim properly, or the engaging protrusions cannot stably install on an inner side of the engraved holes of the aluminum alloy wheel rim. Therefore, the conventional wheel cover is difficult to install on the aluminum alloy wheel rim commonly manufactured by different foundries, which brings troubles to the development and design of the wheel cover, and its overall structural design still needs to be improved.

### SUMMARY OF THE INVENTION

The present invention relates to an embedding structure for a wheel cover fitted to an aluminum alloy wheel rim which has a supporting seat to expand plural engaging legs of a wheel cover outwardly and engage in a shaft hole of a wheel rim, so as to easily and conveniently position and install on the wheel rim and improve its whole practical feature.

A purpose and an effect of the embedding structure for a wheel cover fitted to an aluminum alloy wheel rim is achieved by the following technical means.

The embedding structure for a wheel cover fitted to an aluminum alloy wheel rim of the present invention comprises a wheel cover and a supporting seat.

The wheel cover comprises a long slot at a middle thereof, plural engaging legs disposed around the long slot at an inner end surface thereof, two withstanding protrusions protruded from an outer end surface thereof at two ends of the long slot, and an engaging groove disposed between the two withstanding protrusions. Each of the plural engaging legs has a positioning protrusion at an outer terminal thereof toward the long slot.

The supporting seat is disposed in a space defined by the plural engaging legs of the wheel cover. The supporting seat comprises a connection segment at a middle thereof, a tenon connected to the connection segment and corresponding to the long slot of the wheel cover, and an annular groove formed at an outer edge thereof and corresponding to the positioning protrusions of each of the plural engaging legs. The annular groove pushes the positioning protrusions of the plural engaging legs outwardly and expands the plural engaging legs outwardly.

Preferably, the positioning protrusion of each of the plural engaging legs has two first chamfered edges respectively at an upper terminal and a lower terminal thereof.

Preferably, each of the two withstanding protrusions has a guiding inclined surface extended in a same direction and corresponding to the engaging groove.

Preferably, the supporting seat has two second chamfered edges respectively at an upper edge and a lower edge thereof.

### BRIEF DESCRIPTION OF THE DRAWINGS

FIG. 1 is an exploded diagram showing an embedding structure for a wheel cover fitted to an aluminum alloy wheel rim of the present invention;

FIG. 2 is a first sectional diagram showing an embedding structure for a wheel cover fitted to an aluminum alloy wheel rim of the present invention in assembly;

FIG. 3 is a partial enlarged sectional diagram along an A-A section of FIG. 2;

FIG. 4 is a stereogram showing an embedding structure for a wheel cover fitted to an aluminum alloy wheel rim of the present invention in use;

FIG. 5 is a second sectional diagram showing an embedding structure for a wheel cover fitted to an aluminum alloy wheel rim of the present invention in assembly;

FIG. 6 is a partial enlarged sectional diagram along a B-B section of FIG. 5.

### DETAILED DESCRIPTION OF THE PREFERRED EMBODIMENT

To provide a thorough understanding, the purpose and advantages of the present invention will be described in detail with reference to the accompanying drawings.

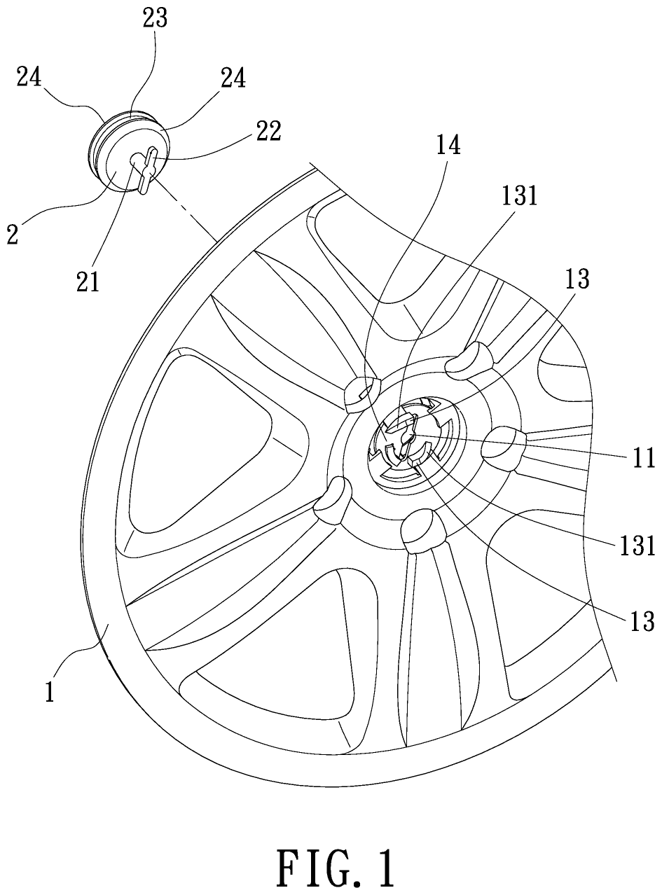

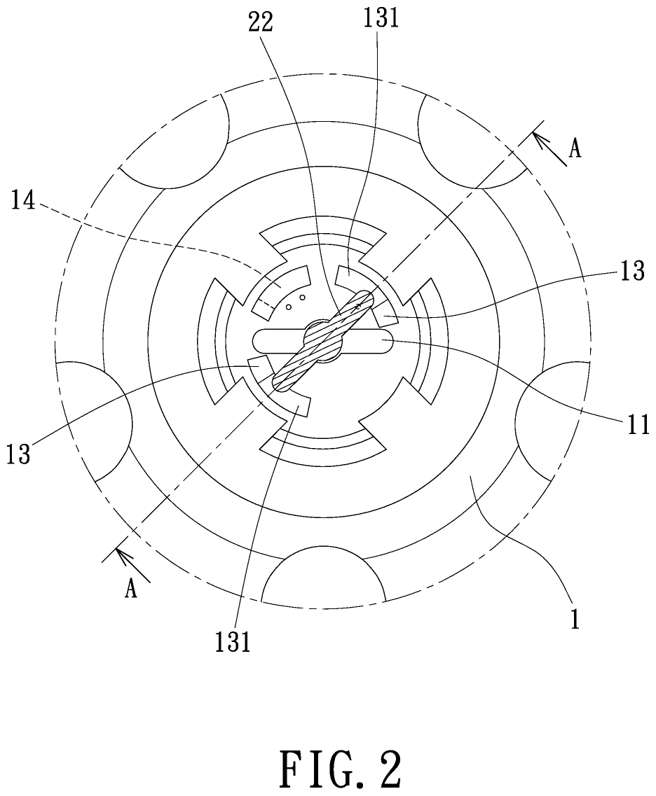

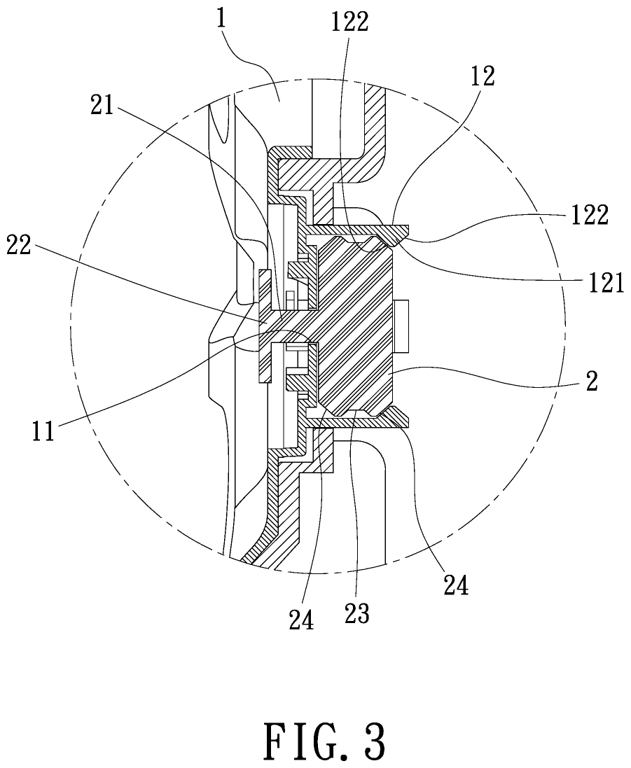

Referring to FIG. 1, FIG. 2 and FIG. 3, the present invention comprises a wheel cover (1) and a supporting seat (2).

The wheel cover (1) comprises a long slot (11) at a middle thereof, is plural engaging legs (12) disposed around the long slot (11) at an inner end surface thereof, two withstanding protrusions (13) protruded from an outer end surface thereof at two ends of the long slot (11) and an engaging groove (14) disposed between the two withstanding protrusions (13). Each of the plural engaging legs (12) has a positioning protrusion (121) at an outer terminal thereof toward the long slot (11) and two first chamfered edges (122) respectively at an upper terminal and a lower terminal thereof. Each of the withstanding protrusions (13) has a guiding inclined surface (131) extended in a same direction and corresponding to the engaging groove (14).

The supporting seat (2) is disposed in a space defined by the plural engaging legs (12) of the wheel cover (1). The supporting seat (2) has a connection segment (21) at a middle thereof, a tenon (22) connected to the connection segment (21) and corresponding to the long slot (11) of the wheel cover (1), an annular groove (23) formed at an outer edge thereof and corresponding to the positioning protrusion (121) of each of the plural engaging legs (12), and two second chamfered edges (24) respectively at an upper edge and a lower edge thereof.

To assemble the present invention, the supporting seat (2) is disposed in the space defined by the plural engaging legs (12) of the wheel cover (1) by facing the connection segment (21) and the tenon (22) to the wheel cover (1) and inserting the tenon (22) into the long slot (11). The supporting seat (2) is then rotated to move the tenon (22) to the position of the withstanding protrusions (13) of the wheel cover (1). Meanwhile, the supporting seat (2) is stored in an inner side of the positioning protrusions (121) of the engaging legs (12) so the wheel cover (1) is convenient to store and transport.

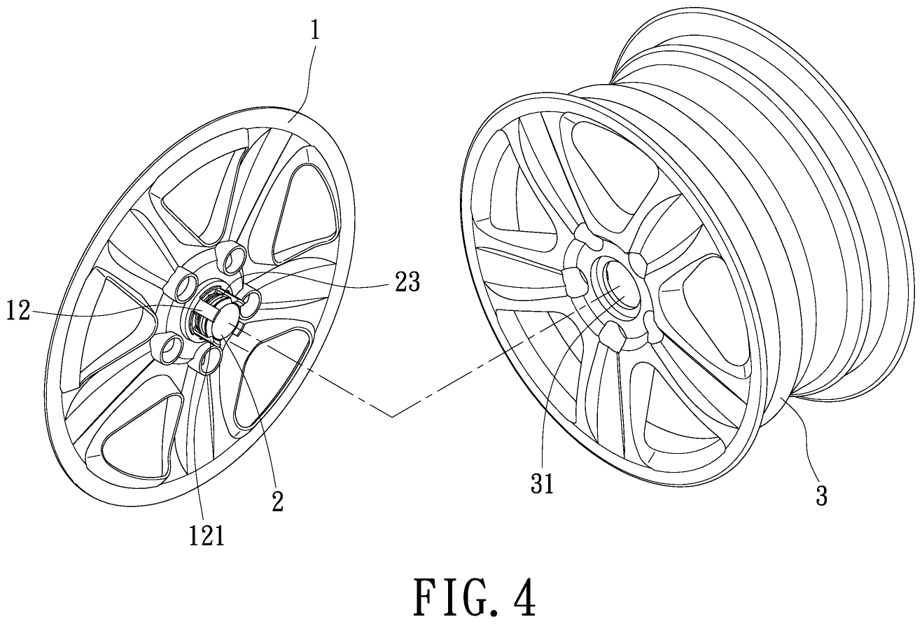

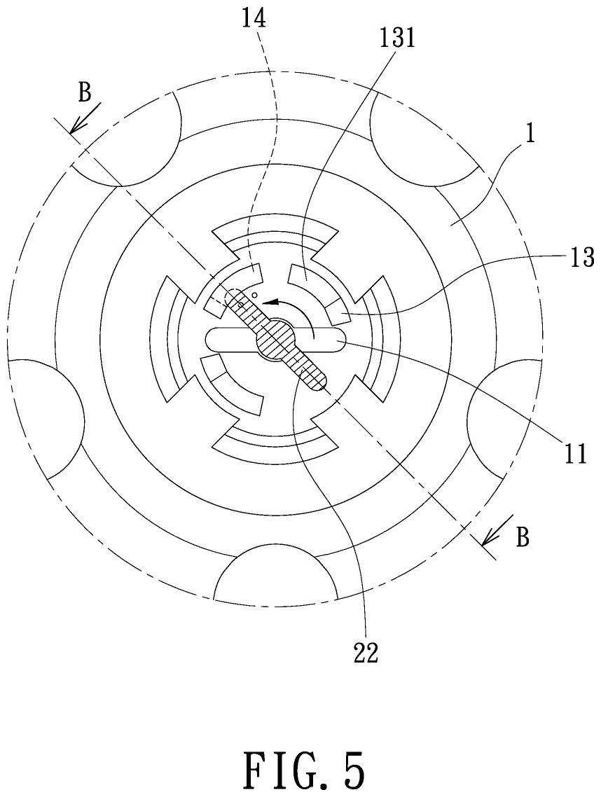

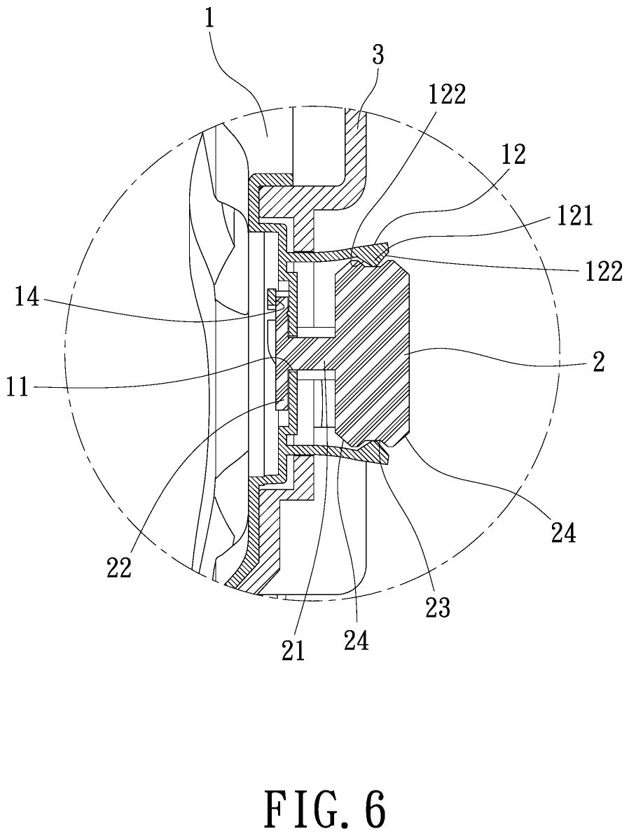

Referring to FIG. 4, in order to install the wheel cover (1) to a car tire, the wheel cover (1) is covered at an outer side of a wheel rim (3) by an inner surface thereof, and the plural engaging legs (12) at the inner end surface of the wheel cover (1) are engaged with a shaft hole (31) of the wheel rim (3). Then, the tenon (22) exposed at an outer end surface of the wheel cover (1) is switched and moved alone the inclined surface (131) of the withstanding protrusions (13) to disposed in and stably engaged with the engaging groove (14). Meanwhile, the supporting seat (2) is pushed by the connection segment (21) and the annular groove (23) at the outer edge of the supporting seat (2) is moved to the position of the positioning protrusions (121) of the engaging legs (12) for engagement. Please referring to FIG. 5 and FIG. 6, the positioning protrusions (121) are pushed outwardly by the annular groove (23) outwardly so as to expand the plural engaging legs (12) outwardly. Therefore, the wheel cover (1) is engaged with the shaft hole (31) of the wheel rim (3) by the expanded engaging legs (12).

In order to disassemble the wheel cover (1) from the wheel rim (3), the tenon (22) at the outer surface of the wheel cover (1) is switched to detach from the engaging groove (14) and moved along the inclined surface (131) of the withstanding protrusions (13) so as to pull the supporting seat (2) by the connection segment (21). The annular groove (23) is then detached from the positioning protrusions (121) of the engaging legs (12) to release the engaging legs (12) from the shaft hole (31) of the wheel rim (3). Therefore, the wheel cover (1) can be removed from the wheel rim (3).

Accordingly, the wheel cover of the present invention is installed on the wheel rim by the engaging legs. The tenon of the supporting seat of the present invention is pushed or switched to change its position from a first position to a second position so as to push and expand the engaging legs of the wheel cover outwardly, and the expanded engaging legs are then engaged with the shaft hole of the wheel rim. Therefore, the present invention achieves effects of easily and rapidly positioning and installing on a wheel rim so as to improve its whole practical feature.

What is claimed is:

1. An embedding structure for a wheel cover fitted to an aluminum alloy wheel rim, comprising:
a wheel cover having a long slot at a middle thereof, plural engaging legs disposed around the long slot at an inner end surface thereof and each having a positioning protrusion at an outer terminal thereof toward the long slot, two withstanding protrusions protruded from an outer end surface thereof at two ends of the long slot and an engaging groove disposed between the two withstanding protrusions; and
a supporting seat disposed in a space defined by the plural engaging legs of the wheel cover and having a connection segment at a middle thereof, a tenon connected to the connection segment and corresponding to the long slot of the wheel cover, an annular groove formed at an outer is edge thereof and corresponding to the positioning protrusion of each of the plural engaging legs for pushing the positioning protrusions of the plural engaging legs outwardly and expanding the plural engaging legs outwardly.

2. The embedding structure for a wheel cover fitted to an aluminum alloy wheel rim as claimed in claim 1, wherein the positioning protrusion of each of the plural engaging legs has two first chamfered edges respectively at an upper terminal and a lower terminal thereof.

3. The embedding structure for a wheel cover fitted to an aluminum alloy wheel rim as claimed in claim 1, wherein each of the two withstanding protrusions has a guiding inclined surface extended in a same direction and corresponding to the engaging groove.

4. The embedding structure for a wheel cover fitted to an aluminum alloy wheel rim as claimed in claim 1, wherein the supporting seat has two second chamfered edges respectively at an upper edge and a lower edge thereof.
